(19) United States
(12) Patent Application Publication
(10) Pub. No.: US 2019/0188764 A1
(43) Pub. Date: Jun. 20, 2019

(54) HIGH END NAIL POLISH MARKETING AND CUSTOMIZATION BOUTIQUE

(71) Applicants: Tamika Broadus, Philadelphia, PA (US); Camea Baksh, Philadelphia, PA (US); Charla Griffen, Philadelphia, PA (US)

(72) Inventors: Tamika Broadus, Philadelphia, PA (US); Camea Baksh, Philadelphia, PA (US); Charla Griffen, Philadelphia, PA (US)

(21) Appl. No.: 15/846,165

(22) Filed: Dec. 18, 2017

(51) Int. Cl. G06Q 30/06; A45D 44/00

(52) U.S. Cl. CPC G06Q 30/0621; A45D 44/005

(57) ABSTRACT

A nail polish boutique comprised of a store front, a displayed inventory of a plurality of nail polishes, and nail polishes offered by a plurality of companies from different countries. The store front offers a custom nail polish mixing service, and uses a computer system maintaining sale and product selection records for each identified customer on a computer database including any furnished custom nail polish formulations.

### CROSS-REFERENCE TO RELATED APPLICATION(S)

Not applicable

### BACKGROUND OF THE INVENTION

### 1. Field of Invention

The present invention relates to the field of nail polish, more particularly to selling nail polish and mixing customized polish.

### 2. Description of Related Art

Nail polish is an important cosmetic product used by millions of women in the US. Although many women routinely, or at least occasionally, go to a nail salon for manicures and/or pedicures, millions continue do their own nails at home.

Despite the wide-spread availability of nail polish for purchase at department stores, grocery stores, drug stores, and beauty supply store, the selections at each of these venues is actually very limited. Traditionally, nail polish is distributed to department and other types of stores and consumers purchase nail polish with their everyday shopping or go to the nail salon and pick from the few selections of nail polish offered.

The nail polish sections in these stores actually offer only a handful selection of colors, and many women pick something available but not something they actually want or looking for. There are also many nail polish companies with not well recognized brands that are in geographically isolated markets and not widely available. Further, nail polish is a major accessory that often gets over looked and should stand out. Some women find that their polish choices are not exactly what they want, and would prefer getting a customized color, shade, or texture (e.g., glitter added).

Based on the foregoing, there is a need in the art a business method which will facilitate increased marketing opportunities of nail polish companies and offers options for customization. adherence through simplified and interactive tracking, alerts, and scheduling.

### SUMMARY OF THE INVENTION

A nail polish boutique comprised of a store front, a displayed inventory of a plurality of nail polishes, and nail polishes offered by a plurality of companies from different countries. The store front offers a custom nail polish mixing service, and uses a computer system maintaining sale and product selection records for each identified customer on a computer database including any furnished custom nail polish formulations.

The nail polishes comprise nail polishes from United States, Mexico, Canada, Europe, Australia, Japan, and China.

The nail polishes comprise enamel, lacquer, gel, acrylic, and shellac types.

The nail polish boutique offering specialized equipment to include at least home UV lamps for curing polish, drying fans, and/or drying lamps.

The nail polish boutique offering specialized polishes and accessories for different finishes to include a plurality selected from chrome, glitter, magnetic, matte, micro-shimmer, opalescent, and satin.

The custom nail polish mixing service provides a customized color, shade, finish, and type.

The custom nail polish mixing service comprises storing custom formulizations in the computer system, to include guidance on components, mixtures, and instructions to produce the custom nail polish.

A method of operating a nail polish boutique, comprising the steps of providing a store front, displaying an inventory of a plurality of nail polishes from a plurality of companies from different countries, offering a custom nail polish mixing service, and maintaining sale and product selection records for each identified customer on a computer database, including any furnished custom nail polish formulations.

The different countries comprise at least the United States, Mexico, Canada, Europe, Australia, Japan, and China.

The nail polishes comprise enamel, lacquer, gel, acrylic, and shellac types.

The method of operating a nail polish boutique further comprises offering specialized equipment to include at least home UV lamps for curing polish, drying fans, and/or drying lamps.

The method of operating a nail polish boutique further comprises offering specialized polishes and accessories for different finishes to include a plurality selected from chrome, glitter, magnetic, matte, micro-shimmer, opalescent, and satin.

The custom nail polish mixing service provides a customized color, shade, finish, and type.

The custom nail polish mixing service comprises storing custom formulizations in the computer system, to include guidance on components, mixtures, and instructions to produce the custom nail polish.

The foregoing, and other features and advantages of the invention, will be apparent from the following, more particular description of the preferred embodiments of the invention, the accompanying drawings, and the claims.

### DETAILED DESCRIPTION OF PREFERRED EMBODIMENTS

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

In an embodiment, the nail polish boutique comprises a store front stocking a wide selection of different nail polishes. The nail boutique can host a variety of nail polish companies, including not only US companies but also Mexican, Canadian, and European nail polish companies, as well as others such as Australia, Japan, China, and other foreign countries. Many such companies have little to no current presence in the US market and can use the nail polish boutique to open the US market for expansion. The boutique can enter into agreements to market and promote foreign companies in the boutiques.

In an embodiment, the nail boutique can offer different types of nail polish and specialized equipment for use in homes. While most consumer outlets only offer lacquer type nail polish, the boutique can offer enamel, lacquer, gel, acrylic, or shellac types. Additionally, the boutique can offer specialized equipment such as home UV lamps for curing polish as well as drying fans and/or drying lamps.

In an embodiment, the nail boutique can offer the specialized polishes and accessories for different finishes and obtaining different finishes such as chrome, glitter, magnetic, matte, micro-shimmer, opalescent, and satin. Additionally, the boutique can offer various decorative stencils and decals. Further, the boutique can provide a training area for providing training to customers on applying nail polish, obtaining various finishes and effects, and using stencils and decals.

In an embodiment, the nail boutique can offer a customized mixing service to arrive at a desired color, shade, finish, and type. For example, a customer may desire a shade and color only available in a lacquer, satin finish in a gel, matte finish. The boutique can have the necessary supplies and resources (pigments, additives, chemicals, etc) to mix and provide to the customer. For such a customized offering, the boutique can sale the customized product under the boutique's brand name. Additionally, various customized formulations can be stored on a computer database, including general guidance on components and mixtures to include instructions to produce the custom nail polish.

In an embodiment, the boutique can maintain sale and product selection records for each identified customer on a computer system that includes customer records stored in a database. These records can further include all custom formulations of nail polish purchased by the customer.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. A nail polish boutique, comprising:
a store front;
a displayed inventory of a plurality of nail polishes, said nail polishes offered by a plurality of companies from different countries;
said store front offering a custom nail polish mixing service; and
a computer system maintaining sale and product selection records for each identified customer on a computer database including any furnished custom nail polish formulations.

2. The nail polish boutique of claim 1, wherein the nail polishes comprise nail polishes from United States, Mexico, Canada, Europe, Australia, Japan, and China.

3. The nail polish boutique of claim 1, wherein the nail polishes comprise enamel, lacquer, gel, acrylic, and shellac types.

4. The nail polish boutique of claim 1, further comprises offering specialized equipment to include at least home UV lamps for curing polish, drying fans, and/or drying lamps.

5. The nail polish boutique of claim 1, further comprises offering specialized polishes and accessories for different finishes to include a plurality selected from chrome, glitter, magnetic, matte, micro-shimmer, opalescent, and satin.

6. The nail polish boutique of claim 1, wherein the custom nail polish mixing service provided a customized color, shade, finish, and type.

7. The nail polish boutique of claim 6, wherein the custom nail polish mixing service comprises storing custom formulizations in the computer system, to include guidance on components, mixtures, and instructions to produce the custom nail polish.

8. A method of operating a nail polish boutique, comprising the steps of:
providing a store front;
displaying an inventory of a plurality of nail polishes from a plurality of companies from different countries;
offering a custom nail polish mixing service; and
maintaining sale and product selection records for each identified customer on a computer database, including any furnished custom nail polish formulations.

9. The method of operating a nail polish boutique of claim 8, wherein the different countries comprise at least the United States, Mexico, Canada, Europe, Australia, Japan, and China.

10. The method of operating a nail polish boutique of claim 8, wherein the nail polishes comprise enamel, lacquer, gel, acrylic, and shellac types.

11. The method of operating a nail polish boutique of claim 8, further comprising offering specialized equipment to include at least home UV lamps for curing polish, drying fans, and/or drying lamps.

12. The method of operating a nail polish boutique of claim 8, further comprises offering specialized polishes and accessories for different finishes to include a plurality selected from chrome, glitter, magnetic, matte, micro-shimmer, opalescent, and satin.

13. The method of operating a nail polish boutique of claim 8, wherein the custom nail polish mixing service provides a customized color, shade, finish, and type.

14. The method of operating a nail polish boutique of claim 8, wherein the custom nail polish mixing service comprises storing custom formulizations in the computer system, to include guidance on components, mixtures, and instructions to produce the custom nail polish.
